(19) United States
(12) Patent Application Publication
(10) Pub. No.: US 2025/0224623 A1
(43) Pub. Date: Jul. 10, 2025

(54) Optical Structure With a Stereoscopic Effect

(71) Applicant: HSUEH-WEN KOU, Taoyuan City (TW)

(72) Inventor: HSUEH-WEN KOU, Taoyuan City (TW)

(21) Appl. No.: 18/404,764

(22) Filed: Jan. 4, 2024

(51) Int. Cl. G02B 30/36

(52) U.S. Cl. CPC G02B 30/36

(57) ABSTRACT

The present invention is an optical structure with a stereoscopic effect. The prism surfaces are comprised of continuous concave and convex surfaces in the longitudinal, while transverse directions are formed on the surface of the optical substrate (molding methods include injection molding, roll molding, etc.). A default image layer is jet printed on the prism surface of the optical structure using a jet printer, so as to form an optical structure that makes the image layer present a stereoscopic effect when it is viewed from the reverse side. Since the depth range of the convex and concave peaks and valleys on the prism surface is 20˜80μ, the pigment of the printed image layer only covers the convex peaks and cannot permeate to the concave valleys, making the valleys transparent without pigment; when the light enters the reverse side of the optical structure, under the reflection and refraction effects at multiple angles, the image layer presents three-dimensional visual changes.

### BACKGROUND OF INVENTION

### 1. Field of the Invention

The present invention relates generally to an optical structure with a stereoscopic effect which is widely used in electronic products, and more particularly to an integrated structure which can display optically visual changes.

### 2. Description of Related Art

The existing flat prints include 2D images and 3D images. The 2D image printing technology is quite mature, but it is visually limited to 2D effects and has certain limitations. The existing 3D image prints generally use an accidented film to produce a 3D effect, which is not only rough, but also produces unsatisfactory visual effects. It is likely to make people feel dazzling, unsoft or even dizzy.

In recent years, young people have been pursuing the form of protective cases for mobile phones. They require dazzling appearance, cool shapes, and novel patterns. Therefore, the manufacturers of spare parts in relation to mobile phones develop and design mobile phone cases. Generally speaking, the most common way is to directly print various 2D image layers (3) on the outer surface of the mobile phone case (4), as shown in FIG. 1; a small number of those with better quality cover a protective transparent film on the surface of the pattern printing layer, and there is a plastic injection mold that prints the image layer (3) on the plastic plate body to form an integrated type.

Although said methods can form images on the surface of the mobile phone case, they simply present the visual effect of 2D images. Apart from adding a little variety to the plain mobile phone case, they have no distinctive features, and they are difficult to create stunning effects. Furthermore, if the image layer is directly printed on the outer side of the mobile phone case, the image layer is likely to be scratched, peel off, and fade due to accidental collisions, drops, and scratches during operation, so that the mobile phone case is replaced or discarded.

The inventor of this project felt that the visual effect of the conventional method of directly printing a 2D image layer on the surface of the substrate was not obvious, so he conducted in-depth research and used his own experience, and proposed an optical structure with a stereoscopic effect, hoping to benefit the public.

### SUMMARY OF THE INVENTION

The main purpose of the present invention is to provide an optical structure with a stereoscopic effect. An optical structure with concave and convex prism surfaces is formed by injection molding, the image layer is jet-printed on the prism surface of the optical structure, which is not completely covered with the pigment, through the reflection and refraction of the incident light, the opposite side of the prism surface of the optical structure presents a visual effect that enhances the image.

Another purpose of the present invention is to provide an optical structure with a stereoscopic effect, which can be produced in a productive manner, save man-hours and costs, and conform to economic value.

In order to attain said purposes, the inventor of this project designed an optical structure with a stereoscopic effect. The optical structure mainly forms an incised prism surface on one surface, and an image layer is printed on the prism surface; the prism surface comprises: a plurality of parallel and equidistant transverse V-shaped grooves, which are interlaced with a plurality of parallel and equidistant longitudinal V-shaped grooves, forming a regular continuous concave and convex pattern on the entire prism surface; the pigment of the image layer only covers the convex peaks of the prism surface, it does not permeate to the concave valleys, making the valleys transparent without pigment.

In a preferred embodiment, the prism surface comprises a plurality of parallel and equidistant transverse cambered V-shaped grooves, which are interlaced with a plurality of parallel and equidistant longitudinal V-shaped grooves.

In an embodiment, the depth range of the longitudinal and transverse V-shaped grooves of the prism surface is 20˜80μ, that below 50μ is the best.

In an embodiment, the angle range of the convex inverted V of the prism surface is 90˜140°.

In a preferred embodiment, the optical structure with a prism surface is applicable to the transparent structure of photo frames.

In a preferred embodiment, the photo image is directly printed on the prism surface of the optical structure instead of the entire photo frame.

In a preferred embodiment, the prism surface can be integrally injection molded by an injection molding machine or formed by rolling.

In a preferred embodiment, the image layer is jet printed by a jet printer.

In order to enable the reviewer to further understand the technology, means and effects used by this invention to achieve the intended purposes, please refer to the following detailed description and drawings about this invention. The purposes, features and characteristics of this invention can be understood in depth and in detail, however, the attached figures are for reference and illustration only, not to limit this invention.

### BRIEF DESCRIPTION OF THE DRAWINGS

FIG. 1 is the implementation diagram of the conventional mobile phone case.

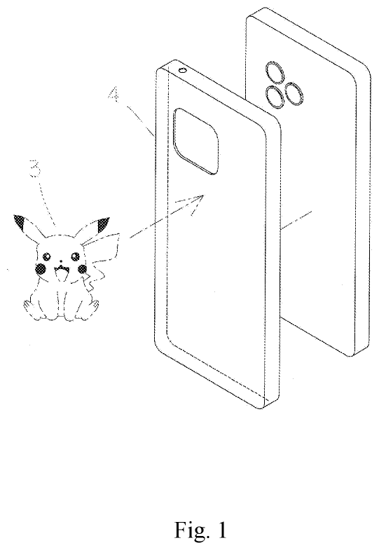

FIGS. 2A, 2B are respectively the plan view and side view of the optical structure substrate in a preferred embodiment of the present invention.

FIGS. 3A, 3B are respectively the plan view and side view of the optical structure substrate in a preferred embodiment of the present invention.

FIGS. 4A, 4B are respectively the partial enlarged view and schematic section of the optical structure in a preferred embodiment of the present invention.

FIG. 5 is the implementation diagram of the optical structure in a preferred embodiment of the present invention.

FIG. 6 is the implementation example diagram of the optical structure in a preferred embodiment of the present invention.

### DETAILED DESCRIPTION OF THE INVENTION

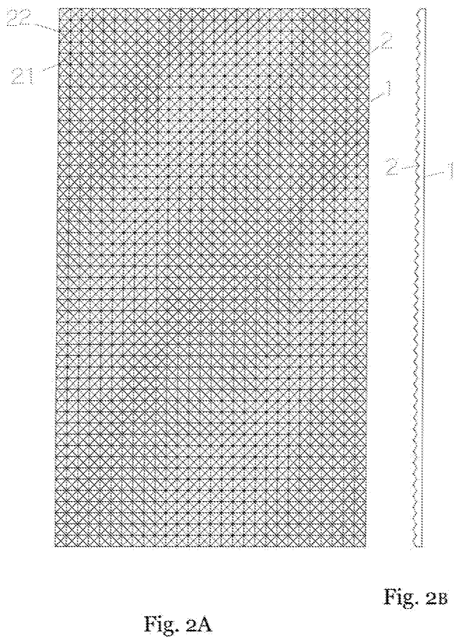

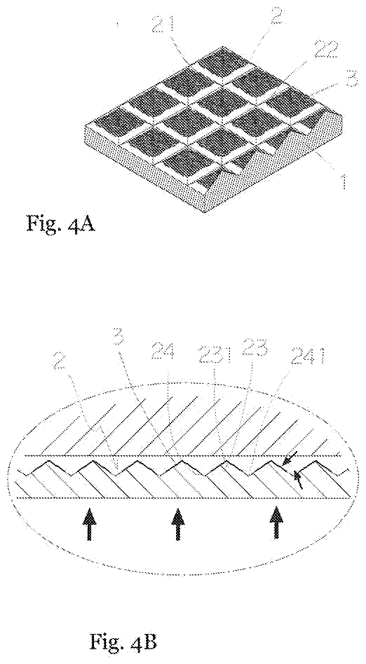

Referring to FIGS. 2A and 2B which disclose the plan view and side view of the optical structure substrate of a preferred embodiment, and FIGS. 4A and 4B which disclose the partial enlarged view and schematic section of the optical structure in a preferred embodiment of the present invention. The optical structure (1) of the present invention in this embodiment is an engraved prism surface formed on the mold core surface of the mold of the plastic injection molding machine, an incised prism surface (2) is naturally formed on the surface of the optical structure (1) after integral injection molding; the production is not limited to this method, the prism surface can be formed by rolling; as shown in FIGS. 4A and 4B, the prism surface (2) comprises: a plurality of parallel and equidistant transverse V-shaped grooves (21), which are interlaced with a plurality of parallel and equidistant longitudinal V-shaped grooves (22), forming a regular continuous concave and convex pattern (23, 24) on the entire prism surface; an image layer (3) is jet printed on the prism surface (2), that is done by a jet printer in this embodiment to achieve the most simple and rapid effect, the pigment of the image layer (3) only covers the peak (231) of the convex portion (23), it does not permeate to the valley (241) of the concave portion (24), making the valley (241) transparent without pigment.

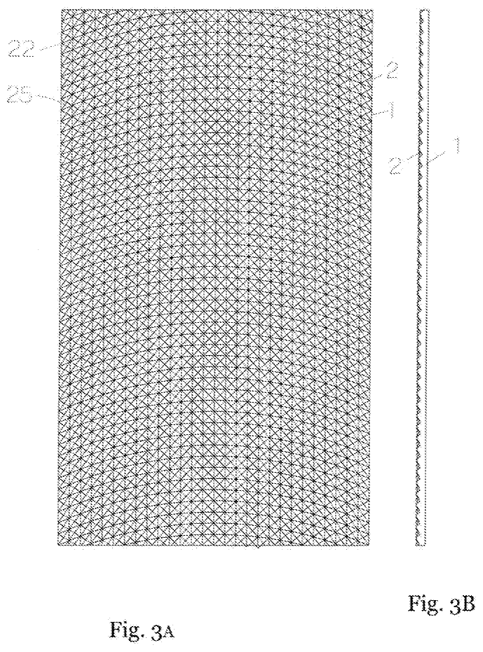

Referring to FIGS. 3A and 3B which disclose the plan view and side view of the optical structure substrate of another preferred embodiment, and FIGS. 4A and 4B which disclose the partial enlarged view and schematic section of the optical structure in a preferred embodiment of the present invention. The prism surface (2) of the optical structure (1) comprises: a plurality of parallel and equidistant transverse cambered V-shaped grooves (25), which are interlaced with a plurality of parallel and equidistant longitudinal V-shaped grooves (22). Similarly, an image layer (3) is jet printed on the prism surface (2), the pigment of the image layer (3) only covers the peak (231) of the convex portion (23), it does not permeate to the valley (241) of the concave portion (24), making the valley transparent without pigment.

Accordingly, the depth range of the transverse and longitudinal V-shaped grooves (21, 22) and the transverse cambered V-shaped groove (25) is 20˜80μ, that below 50μ is the best; the angle range of the inverted V of the convex (23) of the prism surface (2) is 90˜140°. The coordinated changes of depth and angle result in different refraction effects of different light incidence angles, so that the user can perceive the visual changes with stereo images at different viewing angles.

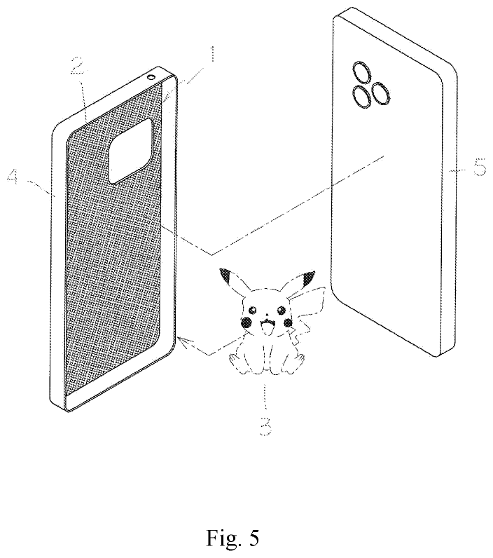

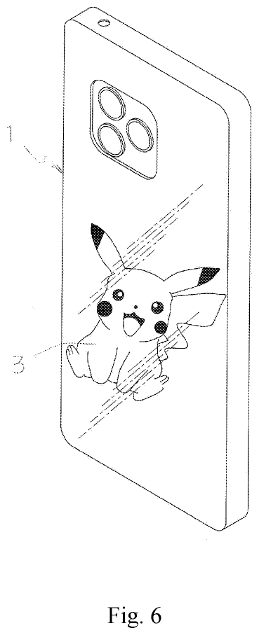

Referring to FIGS. 5 and 6, in terms of implementation, the optical structure (1) can be used for mobile phone cases. The inner surface of the mobile phone case (4) is provided with a prism surface (2), the required image layer (3) is jet printed on the prism surface (2), and then the mobile phone case (4) is combined with the mobile phone (5); thus, when you look at the image layer (3) on the mobile phone case (4) from the opposite side, the light enters the optical structure (1), and through the interaction of reflection and refraction at multiple angles, the image layer (3) presents more stereoscopic visual change effects. In addition, the optical structure (1) of the present invention is applicable to the transparent structure of photo frames, it can also enhance the colors and the stereoscopic effects of the original photos, or the photo image in the original photo frame can be transferred to the jet printer, and the photo image is directly jet printed on the prism surface (2) of the optical structure (1).

To sum up, the characteristics of the optical structure with a stereoscopic effect of the present invention include: 1) It is a flat or cambered substrate which is integrally formed from plastics by an injection molding machine, an incised prism surface is formed on one side of the substrate, including a plurality of regularly arranged longitudinal and transverse V-shaped grooves, forming a continuous concave and convex arrangement design. An image is jet printed on the prism surface of the optical structure. However, the image pigment can only cover the convex parts, it does not fully fall into the concave parts, because the V-shaped grooves are too small, resulting in a small portion of the entire image remaining transparent without pigment. When you look at the opposite surface of the optical structure, the mixed reflection and refraction combination effect produced when the light enters the prism surface achieves the visual effect of enhanced colors. 2) In the manufacturing process, the optical structure with the prism surface can be completed by injection molding, which can increase production and save man-hours and costs.

The optical structure with a stereoscopic effect of the present invention can positively provide a structural design that is completely different from the conventional ones through the technical content disclosed above, which can improve the overall use value. Moreover, it has not been seen in periodicals or used in public before the application. It has conformed to essentials of utility model patents.

Although the invention has been explained in relation to its preferred embodiment, it is to be understood that many other possible modifications and variations can be made without departing from the spirit and scope of the invention as hereinafter claimed.

1. An optical structure with a stereoscopic effect, the optical structure mainly forms an incised prism surface on one surface, the prism surface comprises: a plurality of parallel and equidistant transverse V-shaped grooves, which are interlaced with a plurality of parallel and equidistant longitudinal V-shaped grooves, forming a regular continuous concave and convex pattern on the entire prism surface; an image layer is jet printed on the prism surface, the pigment only covers the convex peaks, it does not permeate to the concave valleys, making the valleys transparent without pigment.

2. The optical structure with a stereoscopic effect defined in claim 1, wherein the prism surface comprises a plurality of parallel and equidistant transverse cambered V-shaped grooves, which are interlaced with a plurality of parallel and equidistant longitudinal V-shaped grooves.

3. The optical structure with a stereoscopic effect defined in claim 1, wherein the depth range of the longitudinal and transverse V-shaped grooves and transverse cambered V-shaped grooves of the prism surface is 20˜80μ, and that below 50μ is the best.

4. The optical structure with a stereoscopic effect defined in claim 1, wherein the angle range of the convex inverted V-shape of the prism surface is 90˜140°.

5. The optical structure with a stereoscopic effect defined in claim 1, wherein the optical structure is applicable to the transparent structure of photo frames.

6. The optical structure with a stereoscopic effect defined in claim 5, wherein the photo image is directly jet printed on the prism surface of the optical structure, replacing the whole photo frame.

7. The optical structure with a stereoscopic effect defined in claim 1, wherein the prism surface can be integrally injection molded by an injection molding machine or formed by rolling.

8. The optical structure with a stereoscopic effect defined in claim 1, wherein the image layer is jet printed by a jet printer.

9. The optical structure with a stereoscopic effect defined in claim 2, wherein the depth range of the longitudinal and transverse V-shaped grooves and transverse cambered V-shaped grooves of the prism surface is 20˜80μ, and that below 50μ is the best.

10. The optical structure with a stereoscopic effect defined in claim 2, wherein the angle range of the convex inverted V-shape of the prism surface is 90˜140°.

11. The optical structure with a stereoscopic effect defined in claim 2, wherein the optical structure is applicable to the transparent structure of photo frames.

12. The optical structure with a stereoscopic effect defined in claim 11, wherein the photo image is directly jet printed on the prism surface of the optical structure, replacing the whole photo frame.

13. The optical structure with a stereoscopic effect defined in claim 2, wherein the prism surface can be integrally injection molded by an injection molding machine or formed by rolling.

14. The optical structure with a stereoscopic effect defined in claim 2, wherein the image layer is jet printed by a jet printer.
